(19) United States
(12) Patent Application Publication
(10) Pub. No.: US 2006/0165476 A1
(43) Pub. Date: Jul. 27, 2006

(54) Latch device for a foldable steering head on an electric motorcycle

(75) Inventor: Samuel Lin, Chiayi (TW)

Correspondence Address: DELLETT & WALTERS, P. O. BOX 82788, PORTLAND, OR, 97282-0788, US

(73) Assignee: SUNPEX TECHNOLOGY CO., LTD.

(21) Appl. No.: 11/040,675

(22) Filed: Jan. 21, 2005

(51) Int. Cl. F16D 1/12

(52) U.S. Cl. 403/94

(57) ABSTRACT

A latch device for a foldable steering head on an electric motorcycle has a base, an inner wheel, and an outer ring. The inner wheel is mounted on the base and has a radius-varying actuating shaft axially penetrating the inner wheel and a latching block radially and movably mounted inside the inner wheel. The latching block has an abutting end and is operationally pushed by the actuating shaft. The outer ring rotatably surrounds the inner wheel and has an inner periphery and multiple detents defined on the inner periphery to operationally engage the abutting end of the latching block so that the latch device locks. By simply pushing the actuating shaft to a radius-narrowing area, the latching block is released from push of the actuating shaft and can move inward to allow the outer ring to rotate. Therefore, the steering head can be conveniently adjusted.

### BACKGROUND OF THE INVENTION

1. Field of the Invention

The present invention relates to a latch device, and more particularly to a latch device on a foldable steering head that makes the steering head operationally and pivotally foldable in a convenient way.

2. Description of Related Art

An electric motorcycle is a convenient transportation device for patients, aged or handicapped people because those people can then move themselves around without assistance from other people.

A conventional electric motorcycle has a seat and the steering head erects in front of the seat so that a space is defined between the seat and the steering head for a rider. However, the conventional electric motorcycle takes up too much space when the motorcycle is not used and the steering head makes a great inconvenience when the conventional electric motorcycle is being transported, such as in shipping. To overcome these drawbacks, the conventional electric motorcycle is modified to make the steering head pivotal to allow the steering head to swing toward the seat. The steering head has a bottom end pivotally secured on the seat by a screw. To firmly secure the steering head on the seat, the screws has to tightly mount at the joint of the steering head and the seat to avoid the steering head displacing when the electric motorcycle moves. Therefore, the rider needs tools and has to spend a great effort to loosen the screw when the steering head is adjusted in different angles or is swung closer to the seat.

To overcome the shortcomings, the present invention provides an improved latch device for the steering head on the electric motorcycle to obviate the aforementioned problems.

### SUMMARY OF THE INVENTION

The main objective of the invention is to provide a latch device for an electric motorcycle wherein the latch device that can be engaged or disengaged conveniently.

Other objects, advantages and novel features of the invention will become more apparent from the following detailed description when taken in conjunction with the accompanying drawings.

### BRIEF DESCRIPTION OF THE DRAWINGS

FIG. 1 is a schematic side view of an electric motorcycle having a latch device in accordance with the present invention;

FIG. 2 is an exploded perspective view of the latch device in FIG. 1;

FIG. 3 is a perspective view of the latch device assembled on the electric motorcycle;

FIGS. 4A and 4B are operational cross-sectional side views of the latch device;

FIGS. 5A and 5B are operational cross-sectional side views showing the movement of a steering head after the latch device is disengaged from the steering head;

FIG. 6 is an exploded perspective view of another embodiment of the latch device in accordance with the present invention; and

FIG. 7 is a cross-sectional side view of latch device in FIG. 6 after assembly.

### DETAILED DESCRIPTION OF PREFERRED EMBODIMENT

A latch device for a foldable steering head on an electric motorcycle in accordance with the present invention comprises a base, an inner wheel, and an outer ring. The inner wheel is mounted on the base and has a radius-varying actuating shaft axially extending through the inner wheel and a latching block radially and movably mounted inside the inner wheel. The latching block has an abutting surface and is operationally pushed by the actuating shaft. The outer ring rotatably surrounds the inner wheel and has an inner periphery and multiple detents defined on the inner periphery to operationally engage the abutting surface of the latching block so that the latch device locks. By simply pushing the actuating shaft to a radius-narrowing area, the latching block is released from pressure of the actuating shaft and can move inward to allow the outer ring to rotate. Therefore, the steering head can be conveniently adjusted.

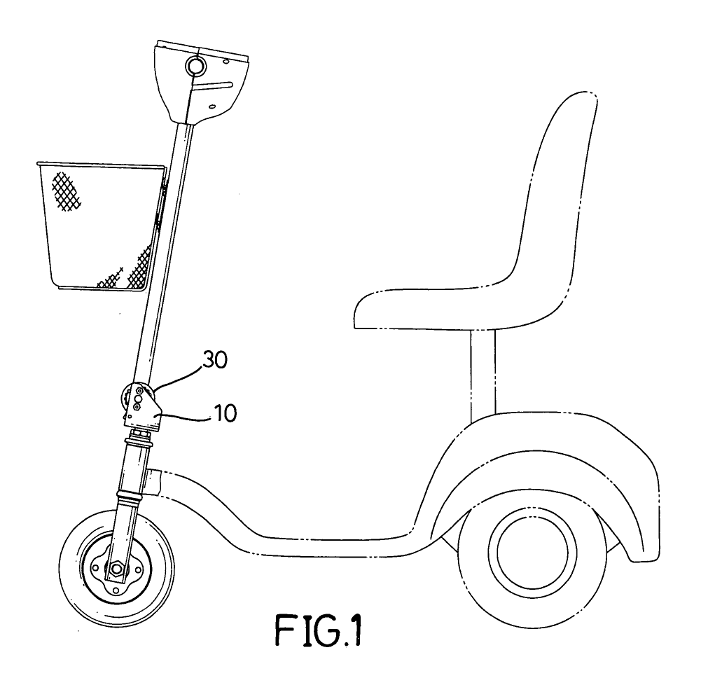

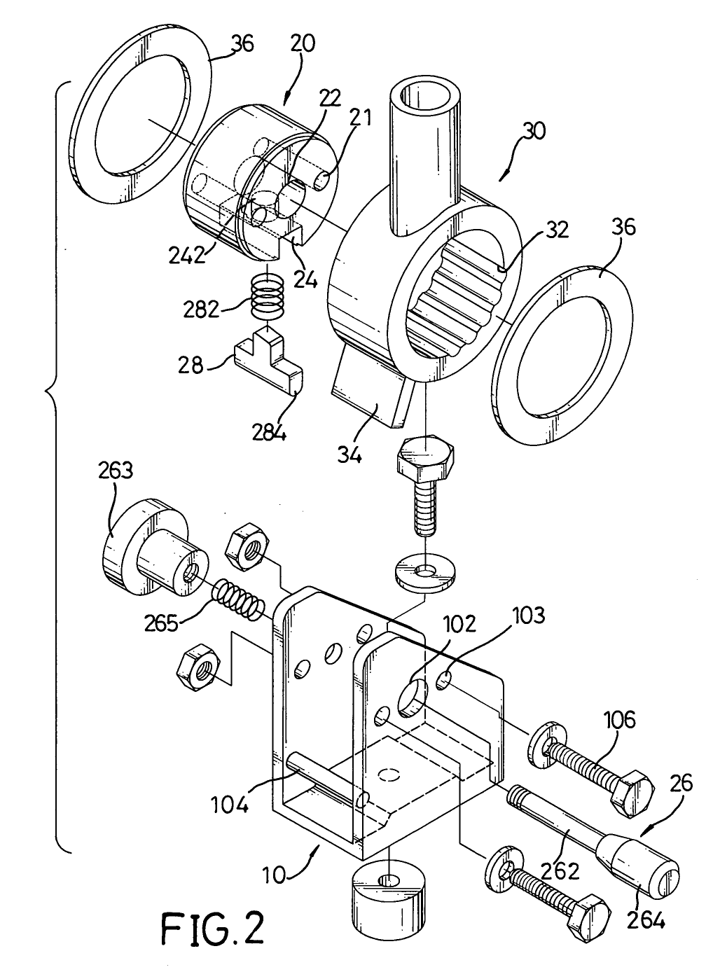

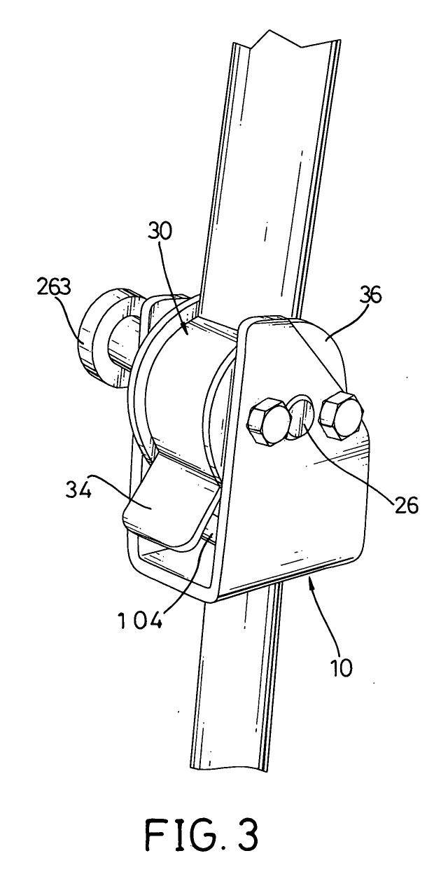

With reference to FIGS. 1 to 3, a preferred embodiment of the latch device in the present invention comprises a base (10), an inner wheel (20) and an outer ring (30).

The base (10) is adapted to mounted on a front frame of the electric motorcycle and is a U-shaped bracket with a bottom and two sidewalls. The base (10) has two through holes (102), four locking holes (103) and a limiting bar (104). The two through holes (102) are respectively defined on the two sidewalls and align with each other. Two of the locking holes (103) are defined beside a corresponding through hole (102) on one sidewall and respectively align with the other two locking holes (103) on the opposite sidewall. The limiting bar (104) extends between the two sidewalls and near the bottom of the base (10).

The inner wheel (20) is mounted on the base (10) and has an axial hole (22), two positioning holes (21), a recess (24), a channel (242), an actuating shaft (26) and a latching block (28). The axial hole (22) is defined axially through the inner wheel to align with the through hole (102) on the base (10). The two positioning holes (21) are defined beside the axial hole (22) and respectively align with the two locking holes (103) on each sidewall of the base (10). Thereby, two bolts (106) respectively penetrate the two positioning holes (21) and the corresponding locking holes (103) to secure the inner wheel (20) on the base (10). The recess (24) is radially defined in the inner wheel (20) and has the channel (242) extending inward to communicate with the axial hole (22). The channel (242) further has a spring recess defined around the channel (242).

The actuating shaft (26) penetrates the through holes (102) on the base (10) and the axial hole (24) on the inner wheel (20). The actuating shaft (26) is composed of a rod (262), an enlarged portion (264), a pressing head (263), and a spring (265). The rod (262) extends through the inner wheel (20) and the base (10) and has two distal ends outside the base (10). The enlarged portion (264) is formed at one distal end of the shaft (26) and has a conical face gradually tapered smaller to the rod (262) so that the actuating shaft (26) has different diameters at the conical face. The pressing head (263) is attached to the other distal end of the rod (262). The spring (265) surrounds the rod (262) and is clamped between the pressing head (263) and a corresponding sidewall of the base (10) to keep the enlarged portion (264) constantly contacting the inner wheel (20).

The latching block (28) is received inside the recess (24) of the inner wheel (20) and is T-shaped block. The latching block (28) has a cross rod, an upright portion, an abutting surface (284), and a spring (282). When the latching block (28) is received inside the recess (24), the upright portion extends through the channel (242) to abut the conical face of the actuating shaft (26). The spring (282) coils around the upright portion and is received inside the spring recess inside the channel (242) to push the latching block (28) outward to contact the outer ring (30). The cross rod has a front end and the abutting surface (284) is defined at the front end.

The outer ring (30) is adapted to attach under the steering head and rotatably surrounds the inner wheel (20). The outer ring (30) has two side faces, an outer periphery, an inner periphery, a stop flange (34), multiple detents (32) and two optional washers (36). The stop flange (34) is formed on the outer periphery of the outer ring (30) to operationally abut the limiting bar (104) on the base (10) when the outer ring (30) rotates to a vertical position of the steering head. Therefore, the steering head can only incline backward to the seat and can not incline forward. The multiple detents (32) are transversally defined through the inner periphery to match the abutting surface (284) of the latching block (28). Additionally, the two washers (36) are respectively clamped between the two side faces and the sidewalls of the base (10) to avoid the outer ring (30) directly abrading the base (10).

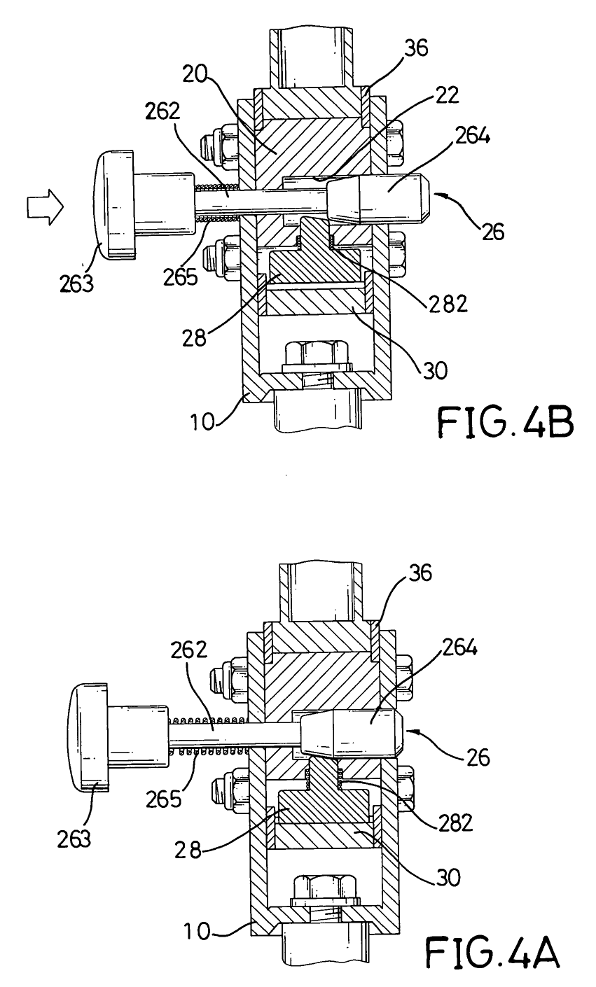

With reference to FIGS. 4A and 4B, when the latch device engages, the enlarged portion (264) on the rod (262) pushes the latching block (28) outward to make the abutting surface (284) engage one corresponding detent (32) inside the outer ring (30). Thereby, the latch device is locked. When the latch device disengages, the pressing head (263) is pressed to make the enlarged portion (264) move aside to release the latching block (28). Meanwhile, the outer ring (30) is free to rotate.

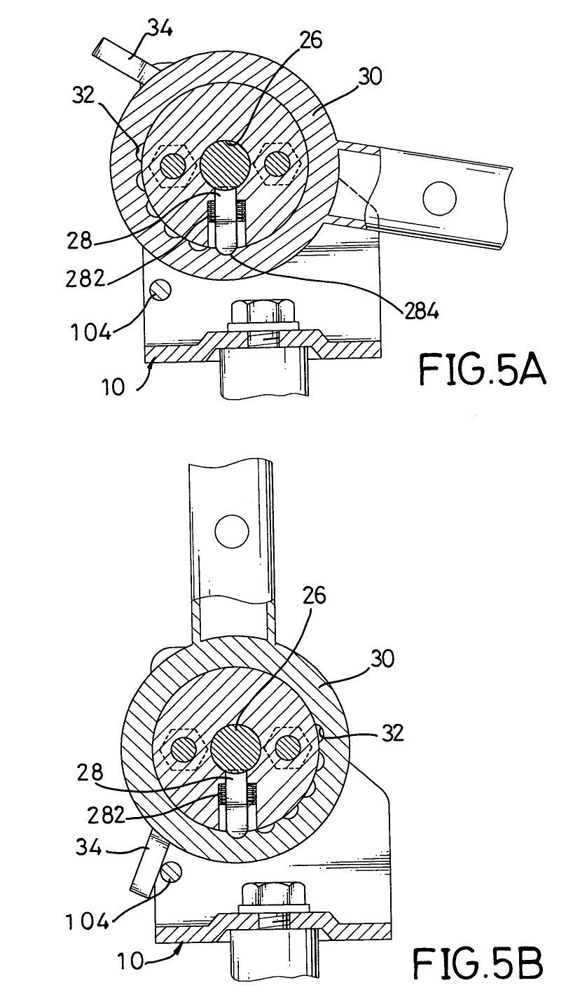

With further reference to FIGS. 5A and 5B, the outer ring (30) can be adjusted to make the latching block (28) engage with different detents and then the pressing head (263) is released to lock the latch device again so that the steering head can be positioned at different inclinations toward to the seat. FIG. 5B further shows the vertical position that is the ultimate position caused by the stop flange (34) and the limiting bar (104).

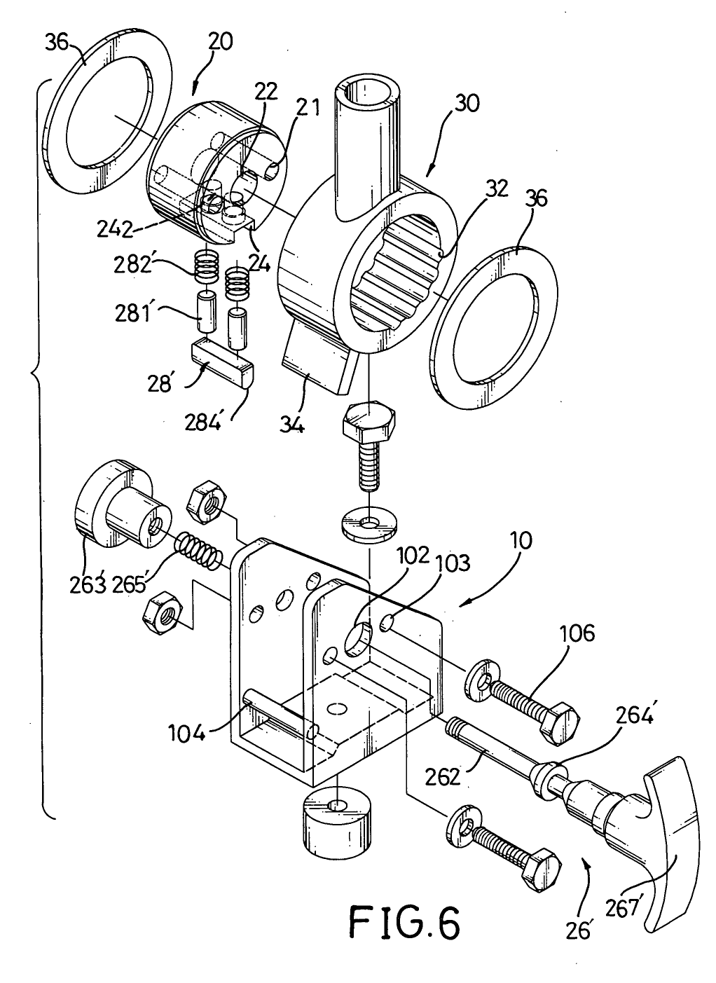

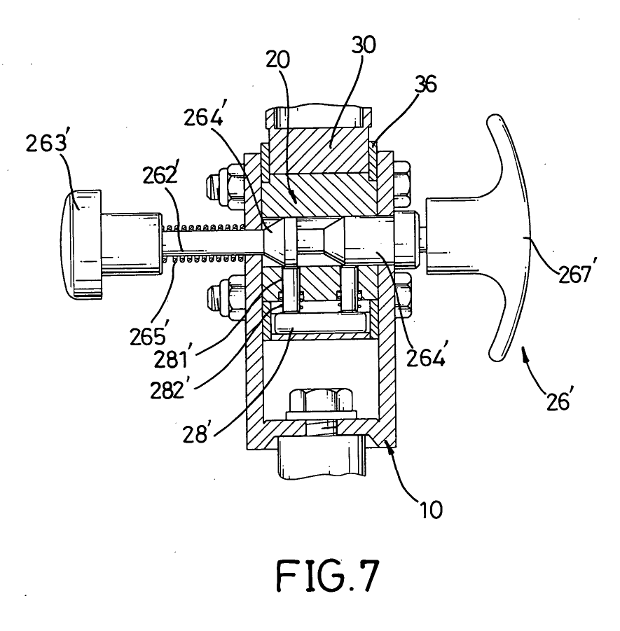

With reference to FIGS. 6 and 7, another preferred embodiment of the latch device in accordance with the present invention has similar structure with the foregoing one except the latching block (28′) and the actuating shaft (26′) are modified. The latching block (28′) is composed of a cross rod with the abutting surface (284′) and two upright portions (281′) clamped between the cross rod and the actuating shaft (26′). Each upright portion (281′) also has a spring (282′) coiled therearound to provide a restitution force to the latching block (28′). Correspondingly, the inner wheel (20) has two channels to accommodate the two upright portions (281′) and the actuating shaft (26′) has two enlarged portions (264′) formed on the rod (262′) to respectively abut the two upright portions (281′) on the latching block (28′). Each channel also has a spring recess defined as in the former embodiment. Additionally, a T-shaped pull bar (267′) is formed at the distal end opposite to the pressing head (263′) so that the actuating shaft (26′) can be moved by pulling the T-shaped pull bar (267′).

According to the above description, the latch device can be operated conveniently by simply pushing or pulling the actuating shaft (26, 26′) without using any tools.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A latch device for a foldable steering head on an electric motorcycle, the latch device comprising:
a base (10);
an inner wheel (20) mounted on the base (10) and having
a radius-varying actuating shaft (26) axially and movably penetrating the inner wheel (20); and
a latching block (28) radially and movably mounted inside the inner wheel (20) and pushed outward by the actuating shaft (26); and
an outer ring (30) rotatably surrounding the inner wheel (20) and having an inner periphery and multiple detents (32) defined on the inner periphery to operationally engage the latching block (28).

2. The latch device as claimed in claim 1, wherein the actuating shaft (26) comprises:
a rod (262) extending through the inner wheel (20) and the base (10) and having two distal ends;
an enlarged portion (264) formed at one distal end of the rod (262), having a conical face gradually tapered smaller to the rod (262) and abutting the latching block (28) at the enlarged portion (264);
a pressing head (263) attached to the other distal end of the rod (262) and having a spring (265) surrounding the rod (262) and clamped between the pressing head (263) and the base (10).

3. The latch device as claimed in claim 1, wherein the latching block (28) is T-shaped and has:
a cross rod with a front end;
an upright portion extending from the cross rod;
an abutting surface (284) formed at the front end; and
a spring (282) surrounding the upright portion;
wherein the inner wheel (20) has:
an axial hole (22) defined axially through the inner wheel (20); and
a recess (24) radially defined in the inner wheel (20), receiving the latching block (28) and having a channel (242) extending inward to communicate with the axial hole (22).

4. The latch device as claimed in claim 2, wherein the latching block (28) is T-shaped and has:
a cross rod with a front end;
an upright portion extending from the cross rod;
an abutting surface (284) formed at the front end; and
a spring (282) surrounding the upright portion;
wherein the inner wheel (20) has:
an axial hole (22) defined axially through the inner wheel (20); and
a recess (24) radially defined in the inner wheel (20), receiving the latching block (28) and having a channel (242) extending inward to communicate with the axial hole (22).

5. The latch device as claimed in claim 4, wherein the base (10) is a U-shaped bracket and has
a bottom;
two sidewalls;
two through holes (102) respectively defined on the two sidewalls and aligning with the axial hole (22) on the inner wheel (20); and
a limiting bar (104) extending between the two sidewalls and near the bottom of the base (10);
wherein the outer ring (30) further has an outer periphery and a stop flange (34) formed on the outer periphery to operationally abut the limiting bar (104).

6. The latch as claimed in claim 5, wherein the inner wheel (20) further has two positioning holes (21) defined through the inner wheel (20) and oppositely beside the axial hole (22);
the base further has two locking holes (103) defined on each sidewall to respectively align with the two positioning holes (21) on the inner wheel (20); and
two bolts (106) respectively penetrate the positioning holes (21) and the correspondingly aligned locking holes (103) to secure the inner wheel (20) on the base (10).

7. The latch as claimed in claim 1, wherein the latching block (28′) comprises:
a cross rod with a front end;
two upright portions (281′) attached to the cross rod;
an abutting surface (284′) formed at the front end; and
two springs (282′) respectively surrounding the two upright portions (281′);
wherein the inner wheel (20) comprises:
an axial hole (22) defined axially through the inner wheel (20); and
a recess (24) radially defined in the inner wheel (20), receiving the latching block (28) and having two channels (242) extending inward to communicate with the axial hole (22);
the actuating shaft (26′) comprises:
a rod (262′) extending through the inner wheel (20) and the base (10) and having two distal ends; and
two enlarged portions (264′) formed on the rod (262′), each enlarged portion having a conical face gradually tapered smaller to the rod (262) and respectively abutting the two upright portions (281′) on the latching block (28).

8. The latch device as claimed in claim 7, wherein the actuating shaft (26′) further has
a pressing head (263′) attached to one distal end of the rod (262′) and having a spring (265′) surrounding the rod (262′) and clamped between the pressing head (263′) and the base (10); and
a T-shaped pull bar (267′) formed at the other distal end of the rod (262′) opposite to the pressing head (263′).
